(19) United States
(12) Patent Application Publication
(10) Pub. No.: US 2012/0040315 A1
(43) Pub. Date: Feb. 16, 2012

(54) TEACHING AID

(76) Inventor: Peter Lawrence King, Victoria (AU)

(21) Appl. No.: 13/202,190

(22) PCT Filed: Feb. 19, 2010
(86) PCT No.: PCT/AU2010/000185

§ 371 Date: Oct. 17, 2011

(30) Foreign Application Priority Data
Feb. 19, 2009 (AU) 2009900703

(51) Int. Cl. G09B 17/00

(52) U.S. Cl. 434/178

(57) ABSTRACT

The present invention relates to the field of voice and speech recognition, in one form, the invention relates to a teaching aid adapted to teach reading and spelling via a voice and/or speech recognition system adapted to assist persons having dyslexia. The invention also provides a mechanism to train a speech recognition system without the need for the used to read verbose passages of text.

### FIELD OF INVENTION

The present invention relates to the fields of teaching aids and voice and speech recognition.

In one form, the invention relates to a teaching aid adapted to teach reading and spelling via a voice and/or speech recognition system adapted to assist persons having dyslexia.

In another form, the present invention enables a dyslexic person to train a computer to recognise their speech patterns. It will be convenient to hereinafter describe the invention in relation to voice and speech recognition suitable for persons with dyslexia, however it should be appreciated that the present invention is not limited to that use only.

### BACKGROUND ART

Throughout this specification the use of the word “inventor” in singular form may be taken as reference to one (singular) inventor or more than one (plural) inventor of the present invention.

Various voice and speech recognition applications have been developed. One example is the Dragon™ voice recognition application. It has been realised that present voice recognition and speech recognition applications require a user to be relatively conversant with the language used by the application. However, many people are not so conversant with language, and thus the present technology presents a substantial obstacle to them using speech and voice recognition technology.

Furthermore, prior art applications require the user to read and write, both of which is difficult for dyslexics. Also existing speech recognition systems require the user to be able to read and speak complex phrases in order to train the speech engine. The invention described within removes this requirement.

The discussion throughout this specification comes about due to the realisation of the inventor and/or the identification of certain related art problems by the inventor and, moreover, any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

### SUMMARY OF INVENTION

An object of the present invention is to an improved application and/or method which will assist dyslexics to read and/or spell.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

In a first aspect of embodiments described herein there is provided a method of, application and/or system for enhancing the reading ability of a user with dyslexia in conjunction with a computer application, comprising selecting a portion of text, enabling the portion of text to be spoken to the user, and enabling the user to thereafter spell at least one word of the portion of text, at least one letter at a time.

Other aspects and preferred forms are disclosed in the specification and/or defined in the appended claims, forming a part of the description of the invention.

In essence, embodiments of the present invention stems from the realization that by the inventor that prior art systems require a user to read and write/type. However, for a user with dyslexia, it is necessary to teach the user to read and spell words and text. The present invention is applicable to any language where characters are combined together to form distinct words. For example, the present invention is applicable to character based languages, rather than Logosyllabic script (symbol or picture) based languages. Characters may include letters, punctuation, numerals. ‘Words and text’ may be words of one or more characters in length, they may be compound words, multiple words, sentences and/or portions of text.

Advantages provided by the present invention comprise the following:

Assists persons with dyslexia to read and spell;

Assists persons with dyslexia to successfully train a speech recognition system;

Enables one or more words to train the users ‘eye’ to read and/or spell;

Assists the user to use a keyboard;

Assists the user to learn the alphabet;

Assists the user to use a computer as a tool for learning;

Provides the user with an increased confidence in speaking, reading and using language;

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not imitative of the disclosure herein, and in which:

FIG. 1 illustrates an example display associated with one embodiment of the present Invention.

### DETAILED DESCRIPTION

In a first embodiment, the present invention has certain text loaded. The text may, for example, be a story. The present invention is executed preferably in 3 stages. An introduction stage, an enrolment stage and a spelling stage. Preferably, these 3 stages are executed one after the other however, the stages may be executed individually, in various combinations or in any order.

### Introduction Stage

The text or story is initially read, verbalised and/or spoken to the user by the present invention. For example a computerised text-to-speech application may be used to verbalise the text. In accordance with an aspect of invention, as the text is spoken, each particular word and/or punctuation is spoken and highlighted to ‘train’ the eye of the user to visualise the text. This stage of the invention may be truncated, restarted and/or resumed by the user as required by the user.

### Enrolment Stage

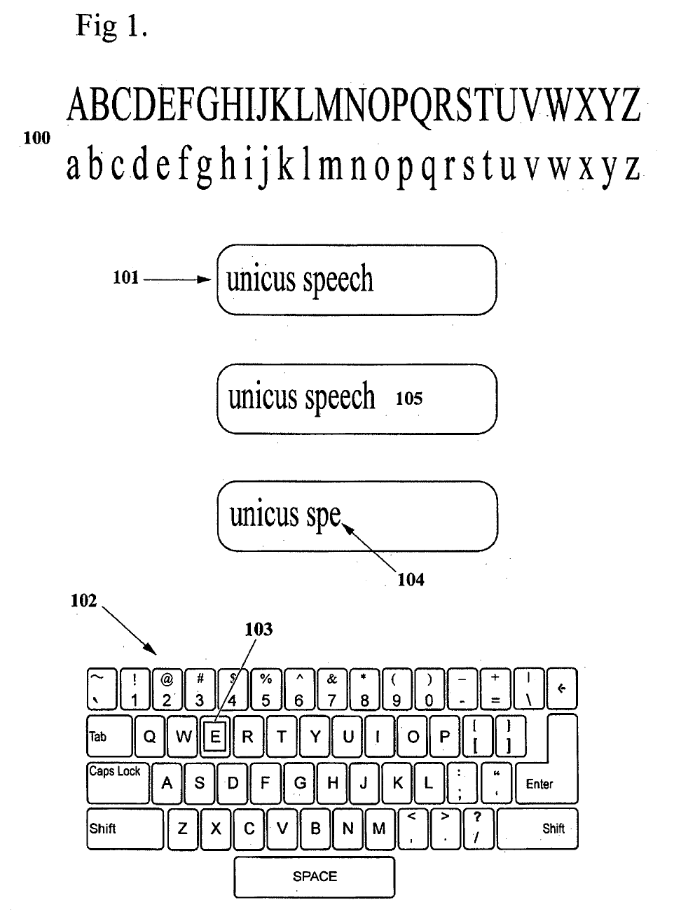

After the introduction stage, the enrolment stage is preferably undertaken. In this stage, the invention also initially verbalises some text. The portion of the text that is spoken may be any one or any combination of:
a word,
a phrase,
a letter,
a numeral,
an indicia,
a sentence, or part thereof
a punctuation
   although any portion of text may be selected and spoken. After a portion of text, for example a word, is verbalised, the invention invites the user to spell that portion of text letter by letter (including punctuation). One embodiment is illustrated in FIG. 1. When the user is asked to spell, the invention will show a screen containing letters of the alphabet 100, the text spoken 101 and/or to be spelt and a keyboard 102. To assist the user, the particular text/punctuation is highlighted on the keyboard 103 and may also be highlighted in the alphabet 100 (for example the letter ‘e’ in FIG. 1). The invention monitors the user. The user input is displayed at 104 to provide feedback to the user. The invention then checks for a correct input from the user before proceeding to the next text/punctuation. In this manner, a user is encouraged to learn to spell whilst visualising not only the correct key strokes on a keyboard but also visualising the portion of text being spelt. At the end of this process the invention facilitates the storage of relevant speech patterns inside the speech engines database.

### Spelling Stage

Preferably following the enrolment stage of the invention, the spelling stage takes place. In this stage the invention verbalises a portion of text 101 (as noted above), after which the user repeats that portion of text and this is displayed 105. Following this, the portion of text is verbalised one letter/punctuation at a time, after which each letter is spoken by the user, and thereafter the letter is typed by the user 104 (again with the keyboard and keys highlighted for assistance to the user). The next letter is then verbalised by the invention, repeated by the user, and typed by the user, and so on.

In a further embodiment, the enrolment and spelling stages are repeated. ‘New’ words and/or text may be included into the dictionary. The text may be input into the application initially or by the user. When the user inputs ‘new’ text, initially the ‘new’ text is typed by the user or an assistant, then the application displays the word, and thereafter asks the user to speak the word. Following this, the application will ask the user to spell or verbalise the new text letter by letter, displaying what is verbalised and seeking further input from the user by typing using keyboard.

Alternatively, a user may select the spelling stage only and/or select the portion of text which is to be used in execution of the present invention.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

It should be noted that where the terms “server”, “secure server” or similar terms are used herein, a communication device is described that may be used in a communication system, unless the context otherwise requires, and should not be construed to limit the present invention to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the invention, it should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a microprocessor, microcontroller, digital signal processor, or general purpose computer), Programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (eg., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (eg, a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (eg., Bluetooth), networking technologies, and inter-networking technologies. The computer program may be distributed in any form as a removable storage medium with accompanying printed or electronic documentation (eg., shrink wrapped software), preloaded with a computer system (eg., on system ROM or fixed disk), or distributed from a server or electronic bulletin board over the communication system (eg., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (eg., VHDL or AHDL), or a PLD programming language (e.g., PALASM, ABEL, or CUPL).

Programmable logic may be fixed either permanently or transitorily in a tangible storage medium, such as a semiconductor memory device (eg., a RAM, ROM, PROM, EEPROM, or Flash-Programmable RAM), a magnetic memory device (eg., a diskette or fixed disk), an optical memory device (eg., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (eg., Bluetooth), networking technologies, and internetworking technologies. The programmable logic may be distributed as a removable storage medium with accompanying printed or electronic documentation (eg., shrink wrapped software), preloaded with a computer system (eg., on system ROM or fixed disk), or distributed from a server or electronic bulletin board over the communication system (eg., the Internet or World Wide Web).

“Comprises/comprising” when used in this specification is taken to specify the presence of stated features, integers, steps or components but does not preclude the presence or addition of one or more other features, integers, steps, components or groups thereof.” Thus, unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

1. A method of enhancing the reading ability of a user with dyslexia in conjunction with a computer application, the method comprising the steps of
selecting a portion of text,
enabling the portion of text to be spoken to the user
enabling the user to thereafter spell at least one word of the portion of text, at least one letter at a time.

2. A method as claimed in claim 1, wherein the portion of text spoken to a user is any one or any combination of:
a word,
a phrase,
a letter,
a numeral,
an indicia,
a sentence, or part thereof
a punctuation.

3. A method as claimed in claim 1, wherein the portion of text spoken to the user is highlighted as it is spoken.

4. A method as claimed in claim 1, further comprising the step of the user typing the at least one word.

5. A method as claimed in claim 4, wherein, in conjunction with the step of typing, a visual indication of the letter to be typed is provided.

6. A method as claimed in claim 5, wherein the visual indication is a display of a keyboard, with letters highlighted.

7. A method as claimed in claim 1, wherein the typing occurs after the spelling.

8. A method as claimed in claim 1, further comprising the step of highlighting the portion of the text to assist in training the eye of the user.

9. A method as claimed in claim 1, wherein the text is spelt one letter at a time.

10. A method of facilitating the training of an automated speech recognition system for dyslexic users, the method comprising the steps of
selecting a portion of text,
enabling the portion of text to be spoken to the user
enabling the user to thereafter spell at least one word of the portion of text, at least one letter at a time.

11. A method as claimed in claim 10, wherein the portion of text spoken to a user is any one or any combination of:
a word,
a phrase,
a letter,
a numeral,
an indicia,
a sentence, or part thereof
a punctuation.

12. A method as claimed in claim 1, wherein the method is applicable to character based language(s).

13. A computer application adapted to enhance the reading ability of a user with dyslexia in conjunction with a computer, the application comprising:
selection means adapted selecting a portion of text,
speech processing means adapted to enable the portion of text to be spoken to the user
feedback means enabling the user to thereafter spell at least one word of the portion of text, at least one letter at a time.

14. An application as claimed in claim 13, further comprising memory adapted to store a record of text spoken by the user.

15. A system adapted to enhancing the reading ability of a user with dyslexia, said apparatus including:
processor means adapted to operate in accordance with a predetermined instruction set, said apparatus, in conjunction with said instruction set, being adapted to perform the following steps:
selecting a portion of text,
enabling the portion of text to be spoken to the user
enabling the user to thereafter spell at least one word of the portion of text, at least one letter at a time.

16. A computer program product comprising:
a computer usable medium having computer readable program code and/or computer readable system code embodied on said medium for execution in association with a data processing system, said computer program product being adapted to enhance the reading ability of a user with dyslexia in accordance with the following steps:
selecting a portion of text,
enabling the portion of text to be spoken to the user
enabling the user to thereafter spell at least one word of the portion of text, at least one letter at a time.

17-18. (canceled)
